(19) United States
(12) Patent Application Publication
(10) Pub. No.: US 2026/0014967 A1
(43) Pub. Date: Jan. 15, 2026

(54) MOTION -BASED FAIL SAFE BRAKING FOR TROLLEYS

(71) Applicant: Ati Motors Inc., Milpitas, CA (US)

(72) Inventors: Venkata Hanuma Sai Teja Tiruvallur, Bengaluru (IN); Sagar Hanumantha, Bengaluru (IN); Ritesh Khatavkar, Belagavi (IN)

(73) Assignee: Ati Motors Inc., Milpitas, CA (US)

(21) Appl. No.: 18/771,793

(22) Filed: Jul. 12, 2024

(51) Int. Cl. B60T 7/20; B60D 1/24; F16D 65/22; F16D 121/16; F16D 125/60; F16D 125/64

(52) U.S. Cl. CPC B60T 7/20; B60D 1/242; F16D 65/22; F16D 2121/16; F16D 2125/60; F16D 2125/64

(57) ABSTRACT

According to embodiments of the present disclosure, a motion based fails safe braking for trolleys is disclosed herein. The trolley includes a brake system that allows for safe operation of the trolley on ramps. The trolley may include various mechanical elements that act as force and displacement multipliers connected to a fixed wheel with a Deadman's brake. The wheel is connected to a hitch point of the trolley. During normal operation, the vehicle that drags the trolley exerts a pull force at the hitch point which releases the brakes, in turn causing the trolley to move. When the tugging operation has ceased, there is no pull force. This releases the brake lever and engages the brake. On gradients and ramps, this braking system ensures there is minimal or no trolley motion.

### TECHNICAL FIELD OF THE INVENTION

This invention in general relates to autonomous mobile robots, and specifically to a universal hitch to detect pull force.

### BACKGROUND

Material movement in industrial environments using trolleys can be automated using self-driving robotic vehicles. However, such automated vehicles still rely on manual interaction at the start and destination, e.g., to load or unload material, to check vehicle state, to charge or replace a vehicle battery, etc.

Loading material on a trolley that is then moved to a different location is a common technique for material movement. Trolleys are typically used for moving specific loads across different surfaces. There is no generic design that exists across all trolleys. Different industries create trolleys based on the particular use case. For example, in the automotive industry, examples of loads transported using trolleys can include tyres, engines, engine parts, panels, other trolleys (in case of Mother-Daughter trolleys), etc.

Various techniques can be employed to move a trolley across a factory floor. For example, trolleys may be moved by human workers, tuggers (electric or internal-combustion engine driven), automated guided vehicles (AGVs), and/or autonomous mobile robots (AMRs). During use, the trolley may be employed on various gradients and ramps. In these kinds of use cases, a safety . . . concern arises, e.g., if the trolley has high loads. For example, there may be concerns of rollback when the trolley is stopped on a ramp or any inclined surface. Conventionally, a manual operation to activate brakes is needed to prevent rollback.

### SUMMARY OF THE INVENTION

This disclosure describes techniques for mechanical fail-safe braking for a trolley. The described techniques can be used for any kind of trolley. The trolley as described herein can be used for material handling and material movement.

In particular, the trolley includes a brake system that allows for safe operation of the trolley on ramps, even when the trolley is coupled to an autonomous vehicle. The trolley includes various mechanical elements that act as force and displacement multipliers connected to a fixed wheel with a Deadman's brake. The wheel is connected to a hitch point of the trolley, e.g., with brake cables via interconnected elements of levers and pulleys. During normal operation, e.g., being dragged by an autonomous/manual tugger, the vehicle that drags the trolley exerts a pull force at the hitch point which releases the brakes, in turn causing the trolley to move. When the tugging operation has ceased, there is no pull force. This releases the brake lever and engages the brake. On gradients and ramps, this braking system ensures there is minimal or no trolley motion even when the pulling system is inactive, or when the tugger is disconnected.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1 illustrates an example of a fail-safe brake trolley parked on a ramp, in accordance with some implementations.

FIGS. 2A, 2B, 2C and 2D illustrates different views of a fail-safe brake trolley, in accordance with some implementations.

FIG. 3 illustrates various components of a trolley with a fail-safe braking system, in accordance with some implementations.

FIG. 4 illustrates an alignment axis along a line connecting rear wheels of a trolley and a direction of motion for the trolley that is perpendicular to the alignment axis, in accordance with some implementations.

FIG. 5 illustrates a hitch pin holder, in accordance with some implementations.

FIG. 6A illustrates how a hitch pin plate moves forward when pull force is applied to release the brakes, in accordance with some implementations.

FIG. 6B illustrates how a hitch pin plate moves to the original position when the pull force is released and engages the brakes, in accordance with some implementations.

FIG. 7A illustrates how a hitch pin plate moves when the applied force is at an angle, in accordance with some implementations.

FIG. 7B illustrates how a hitch pin plate moves when the applied force is straight, in accordance with some implementations.

FIG. 8 illustrates a brake wire tensioner, in accordance with some implementations.

FIG. 9A, 9B illustrates different views of a pulley that reduces the displacement required by the hitch pin holder to release the brakes, in accordance with some implementations.

FIG. 10 illustrates a Deadman's fixed castor, in accordance with some implementations.

FIG. 11 illustrates a mechanical lever, in accordance with some implementations.

### DETAILED DESCRIPTION OF THE INVENTION

The presently disclosed subject matter now will be described more fully hereinafter with reference to the accompanying figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated figures. Therefore, it is to be understood that the presently disclosed subject matter is not to be limited to the specific embodiments disclosed and that modifications and other embodiments are intended to be included within the scope of the appended claims.

Self-driving vehicles offer many advantages-reduction in expense owing to saving labor costs; suitability for operation in tight spaces where conventional, manually-driven vehicles cannot operate; flexibility in design of shape; etc. Self-driving vehicles can operate in both indoor and outdoor environments. The vehicle and associated systems described herein can achieve autonomous movement in limited mapped environments such as private industrial spaces, warehouses, etc.

In an autonomous mobile robot (AMR) or other self-driving vehicle, data from sensors such as a light detection and ranging sensor (LiDAR) and one or more other sensors such as a camera, radar, etc. can be used to accurately detect objects and landmarks in an environment, for e.g., trolley, ramps, speed humps, gangways, storage racks, automation accessories such as trolley hitch, conveyors.

An AMR may be used for material movement. For example, a trolley may be coupled to the AMR. A fail-safe brake trolley is described herein that is suitable for use with an automated vehicle, or to provide automatic braking, and that can be used to safely move loads across surfaces that may have a slope or gradient, e.g., ramps.

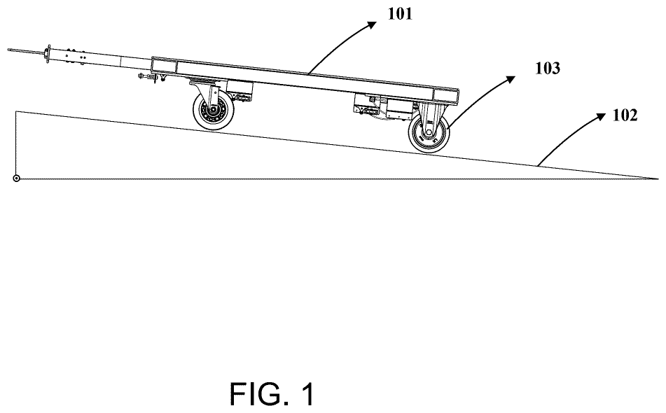

FIG. 1 illustrates an example of a fail-safe brake trolley parked on a ramp, in accordance with some implementations. The trolley101 is positioned on the ground 102 surface with wheels 103 touching the ground. With the fail-safe brake engaged, the trolley can be safely parked on an inclined surface or ramp.

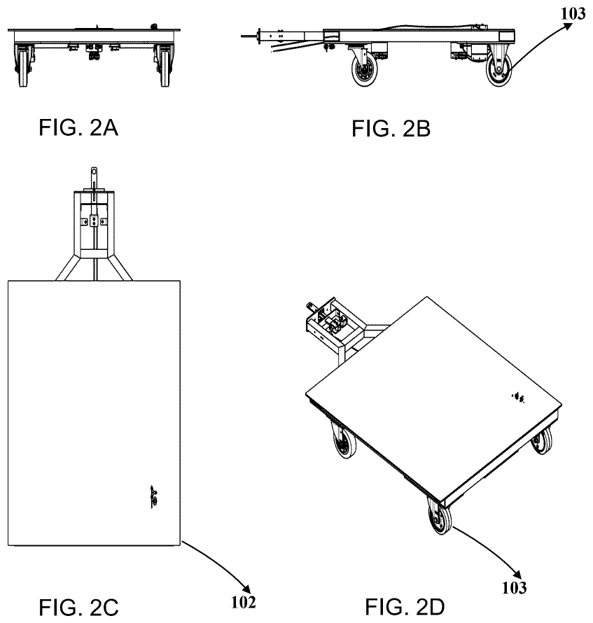

FIGS. 2A, 2B, 2C and 2D illustrates different views of a fail-safe brake trolley 101, in accordance with some implementations.

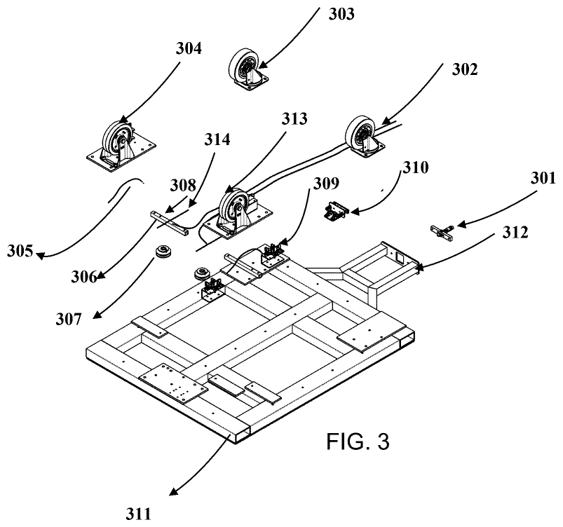

FIG. 3 illustrates various components of a trolley 101 with a fail-safe braking system, in accordance with some implementations. The trolley 101 includes a hitch pin holder 301, swivel castor wheels 302, 303; Deadman's brake fixed castor wheel (right wheel 304 and left wheel 313), brake cables 305, 306, pulleys 307, mechanical levers 308, a brake wire routing conduit 309, a brake wire tensioner 310, trolley base 311, brake wires that connect a hitch pin plate to mechanical levers 302, and a base plate 312.

The hitch pin holder 301 can be utilized to couple the trolley 101 to an autonomous mobile robot (AMR), an automated guided vehicle, a tugger, or any other vehicle. In particular, a ping can be utilized to couple the trolley to the AMR or other vehicle. Primary function is to connect Tugger/Automated Guided Vehicles/Autonomous Mobile Robots with the trolley 101, with the help of a pin. The holder holds the pin that connects the AMR with the trolley. The AMR includes a hitch with a hole type connector. The trolley can be attached to any AMR or tugger or vehicle that has a hole type connector.

Swivel castor wheels 302, 303 are provided and can steer the trolley 101 when attached to a vehicle. For example, two swivel castor wheels 302, 303 can be provided, as shown in FIG. 3. However, depending on the trolley size, weight to be carried, etc., any number of swivel castor wheels can be provided.

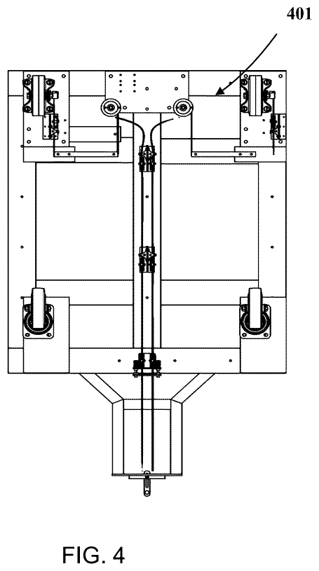

The trolley 101 further includes a right Deadman's brake fixed castor wheel 304 and a left 313 Deadman's brake fixed castor wheel (4). In some implementations, the wheel configuration on the right and left Deadman's brake castor wheel is aligned in the same axis and perpendicular to the direction of motion, as illustrated in FIG. 4. Further, additional wheels in the alignment axis can be added to increase weight capacity of the trolley. The wheels can be traditional fixed or swivel castor wheels.

Brake cables 305, 314 are provided. The brake cables 305, 314 transmit force between the brake and a mechanical lever 306. Pulleys 307 are provided and act as displacement multipliers. A brake wire routing conduit 309 and brake wire tensioner 310 are also provided.

The trolley has a trolley base 311. Brake wires 302 are provided that connect the hitch pin 301 plate and the mechanical lever 306. The trolley 101 includes a base plate 311. The base plate 311 functions as a foundation to fix various modules to the trolley for various functions. FIG. 3 illustrates the trolley in an upside down position.

FIG. 4 illustrates an alignment axis along a line connecting rear 303, 3013 wheels of a trolley and a direction of motion for the trolley that is perpendicular to the alignment axis 401, in accordance with some implementations.

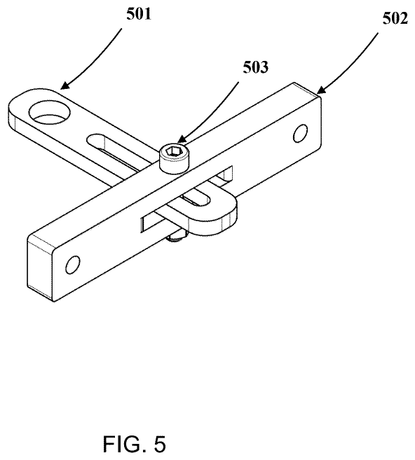

FIG. 5 illustrates a hitch pin holder, in accordance with some implementations. The hitch pin holder includes a hitch pin plate 501. A mount plate 502 holds the hitch pin plate 501 to the base plate 312 of the trolley. A pin 503 allows for the hitch pin plate to slide and rotate about the pin. In operation, the hitch pin plate holds the tugger/AGV/AMR on one side with a pin 503 while the opposite end holds the single brake cable from the brake wire tensioner 310 of the trolley. The configuration, as illustrated in FIG. 4, allows the trolley a degree of lateral freedom along the alignment axis as the trolley is tugged by the tugger/AGV/AMR.

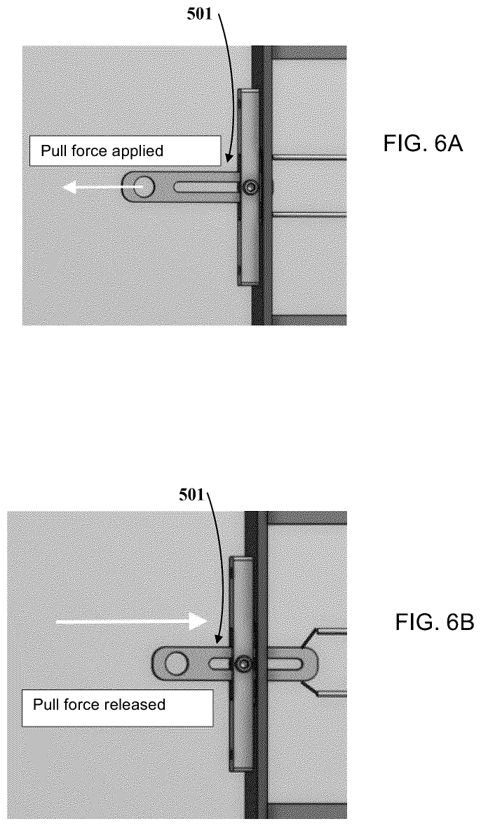

FIG. 6A illustrates how the hitch pin plate 501 moves forward when a pull force is applied to release the brakes, in accordance with some implementations.

FIG. 6B illustrates how the hitch pin plate 501 moves to the original position when the pull force is released and engages the brakes, in accordance with some implementations.

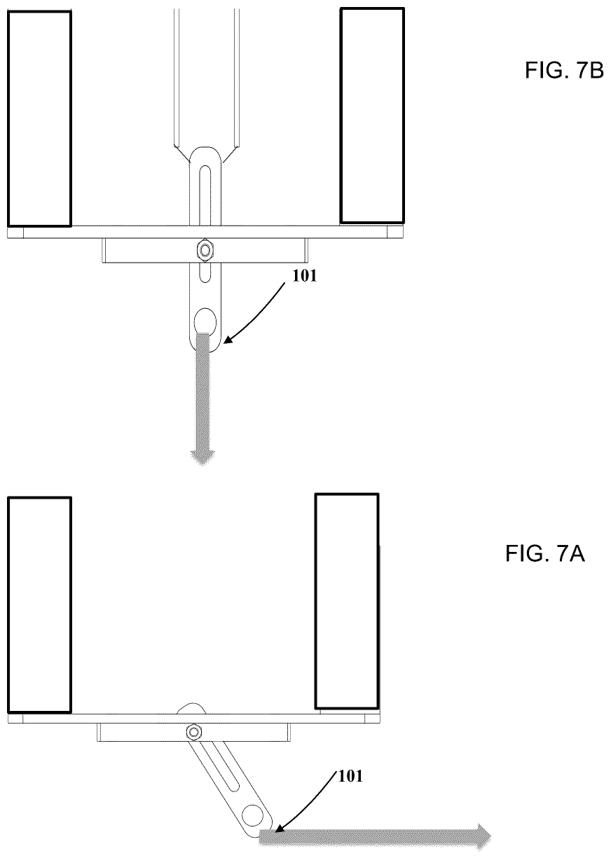

FIG. 7A illustrates how the hitch pin plate 501 moves when the applied force (e.g., from a vehicle to which the trolley is coupled) is at an angle, in accordance with some implementations. The arrow in FIG. 7A indicates the direction of the applied force.

FIG. 7B illustrates how a hitch pin plate 501 moves when the applied force, for example from a vehicle to which the trolley is coupled is straight, in accordance with some implementations. The arrow in FIG. 7B indicates the direction of the applied force.

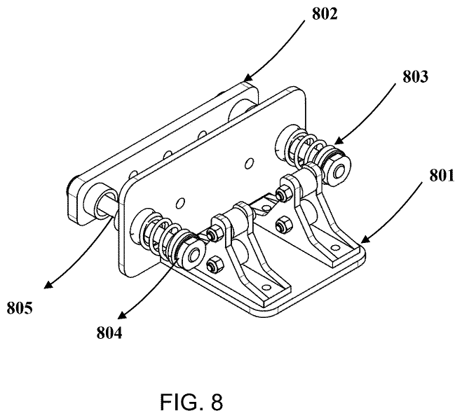

FIG. 8 illustrates a brake wire tensioner, in accordance with some implementations. A brake wire tensioner 310 can be used in a trolley. The brake wire tensioner 310 includes a chassis 801, a small plate 802 the brake wires from the left and right side brake castor wheels 313, 304 to a brake wire that connects to the hitch pin holder. Springs 803 are provided to create tension in the brake cables. A washer cap 804 holds the spring in place. Pin 805 moves linearly when force is applied.

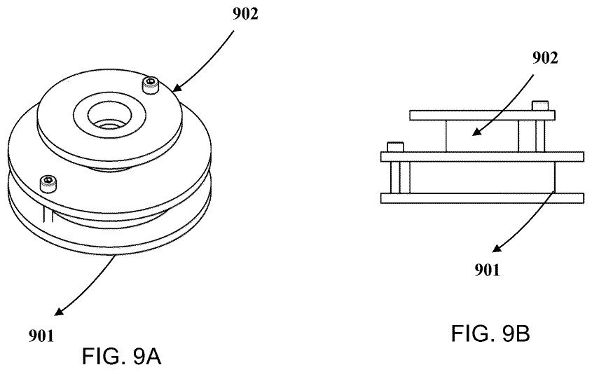

FIG. 9A, 9B illustrate different views of a pulley that reduces the displacement required by the hitch pin holder to release the brakes, in accordance with some implementations. The pulley includes a large radius pulley 901 and a small radius pulley 902. In some implementations, the small radius pulley 902 has a radius that is half of the radius of the large radius pulley 901. Displacement of the brake wire 302 reduces by an equivalent factor.

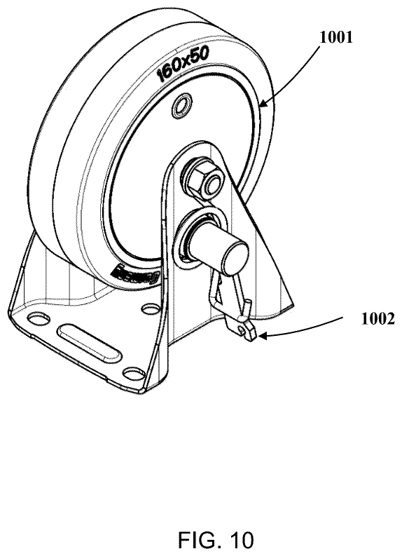

FIG. 10 illustrates a Deadman's fixed castor, in accordance with some implementations. The Deadman's fixed castor includes an integrated wheel 1001 with a drum brake inside and a spring-loaded lever that helps reduce the amount of pull force necessary to disengage the drum brake 1002. The Deadman's fixed castor can be used Deadman's brake fixed castor wheel (right wheel 303 and left wheel 304) described with reference to FIG. 3.

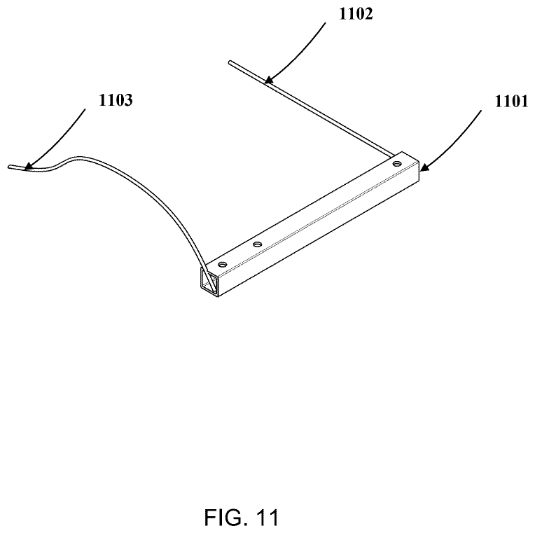

FIG. 11 illustrates a mechanical lever, in accordance with some implementations. The mechanical lever includes a lever 1101 that is usable to multiply force, a brake cable 1102 between the lever and a Deadman's Fixed Castor 313, 304 and a brake cable 1103 connected to the pulley 307.

In operation, the fail-safe brake trolley as described herein can be hitched to a tugger/AGV/AMR using a trolley pin (that is part of the tugger/AGV/AMR). Components of the fail-safe brake trolley are described above with reference to FIG. 3. The pin is placed in the hitch pin plate (HPP), described with reference to FIG. 5, on the hitch pin holder 301. When a pull force is applied in the forward direction the hitch pin plate moves in the direction of the force moves until it comes to a hard stop by coming into contact with the pin 503. At this point, the vehicle connected to the trolley via the HPP pulls the trolley along with any load placed on the trolley. When the vehicle takes a turn, causing the trolley to turn, the HPP pivots about the pin, enabling the trolley to continue to move.

The HPP is connected to the brake wire tensioner 302, 303 via metallic (or other suitable material) brake cable (FIG. 3, 11). In some implementations, any material with a minimum brake load of more than 1 kilonewton may be used for the brake cable. A primary function of the brake wire tensioner (BWT) is to maintain the brake cable in constant tension to avoid slack in the setup.

Any slack on the brake cable 302 increases the displacement necessary for brake action, whereas the slot length on the HPP 501 is fixed. Thus, slack on the brake cable can cause the braking action to not be complete. The primary elements of the BWT, as illustrated in FIG. 8, include springs 803 and small plate 802 that connect the two brake wires 302 from Deadman's castor wheels 304, 313 to the HPP 501. After the HPP 501 is released, the springs recoil back to their original position and maintain the tension of the brake cable. The tension of the springs can be adjusted, e.g., using the washer cap 804. The pin 805 restricts the movement of the small plate 802 to the direction of motion 401 perpendicular to the alignment axis, as illustrated in FIG. 4.

Brake cables 302 are connected from brake wire tensioner 310 to the pulley 307. The pulley acts to reduce the displacement required by the HPP 501 to release the brakes 304, 313. In some implementations, this is accomplished by a rigid pulley with two different radii, as illustrated in FIG. 9.

The arc length is proportional to the radius of the pulley and the angle. For the same angle moved, the two different radii pulleys move proportional to their respective radius. In some implementations, the larger pulley 901 is twice as large in radius as the smaller pulley 902 effectively reducing the displacement by that proportion. The pulley can be modified based on the requirements of pull force in various applications.

As illustrated in FIG. 11, the pulley is connected to the mechanical lever via a brake cable 1103. The lever multiplies force while increasing the displacement. The displacement is reduced by the pulley as mentioned before. This arrangement enables achieving a balance of the total displacement required for braking. A brake cable 1102 is attached to the Deadman's Fixed Castor 304, 313 from the mechanical lever.

As illustrated in FIG. 10, the Deadman's fixed castor wheels include an internal drum brake 1001. In various implementations, other types of brakes such as disc brakes can be used as long as the brake is a Dead Man's Brake attached to Deadman's spring release mechanism. When a pull force is applied to the lever 1002 of the Deadman's fixed castor, the brake is released and the wheel is free to move as illustrated in FIG. 6A.

When a pull force is applied to the HPP 301, the brake cable that is connected HPP and BWT 310 displaces, pulling the small plate 802. The small plate is held in tension by springs 803. The pull force moves the brake cables that are connected to the mechanical lever via pulleys (this multiplies the displacement). The mechanical lever then pulls the lever of the Deadman's brake castor. This releases the brake and the wheel is free to rotate. The mechanical lever acts as a force multiplier.

Even on Ramps, as illustrated in FIG. 1, when a pull force is applied, the pin moves the HPP that is connected to the Deadman's castor via pulleys and mechanical lever, releasing the brake and enabling the wheel to rotate freely.

The tuning of the pull force can be done by changing the ratio of length 1 and length 2 of the mechanical lever, referring to FIG. 11. The amount of pull force required for brake release is pre-set by design of mechanical lever, as illustrated in FIG. 11. This is the minimum pull force required to be exerted by Tugger/Automated Guided Vehicle/Autonomous Mobile Robot to which the trolley is coupled to release the brakes and move the trolley. The load on trolleys does not change the minimum pull force required by the pin to release the brakes. The sizing of the Deadman's brake castor can be based on the load rating of a given trolley. The load on the trolley can be used to size the maximum pulling force of the Deadman's castor wheel.

The pull force on the HPP is removed when the AMR stops. The springs on Deadman's Castor pull back the brake cable creating a lock on the wheel via a drum brake. The whole brake cable system is held in tension by the Springs 803 on BWT 310 and Deadman's castor 304, 313.

The foregoing examples have been provided merely for explanation and are in no way to be construed as limiting of apparatus disclosed herein. While the apparatus has been described with reference to particular embodiments, it is understood that the words, which have been used herein, are words of description and illustration, rather than words of limitation. Furthermore, although the apparatus has been described herein with reference to particular means, materials, and embodiments, the apparatus is not intended to be limited to the particulars disclosed herein; rather, the design and functionality of the apparatus extends to all functionally equivalent methods, structures and uses, such as are within the scope of the appended claims. While particular embodiments are disclosed, it will be understood by those skilled in the art, having the benefit of the teachings of this specification, that the apparatus disclosed herein is capable of modifications and other embodiments may be effected and changes may be made thereto, without departing from the scope and spirit of the apparatus disclosed herein.

1. A fail safe brake system for a trolley connected to a vehicle, comprising:
a left deadman's brake fixed castor wheel;
a right deadman's brake fixed castor wheel;
a mechanical lever, further comprising a lever to multiply force, and a first brake cable between said lever and said left and right deadman's brake fixed castor wheels, and a second brake cable connected to a pulley system, and wherein said first and second brake cables that transmit force between said brake and said mechanical lever;
said pulley system further comprises a small radius pulley and large radius pulley, wherein said pulley system reduces the displacement required by the hitch pin holder to release the brakes;
a brake wire routing conduit;
a brake wire tensioner that maintains the brake cable in constant tension to avoid slack;
trolley base;
brake wires that connect a hitch pin plate and said mechanical lever; and
a hitch pin holder to couple said trolley to said vehicle, wherein the hitch pin plate holds the vehicle on one side with a pin while the opposite end holds a single brake cable from the brake wire tensioner of the trolley, whereby the trolley is provided a degree of lateral freedom as the trolley is tugged by said vehicle;
a small plate held in tension by springs;
wherein when a pull force is applied to a hitch pin plate, the brake cable displaces, pulling said small plate, and the pull force moves the brake cables that are connected to the mechanical lever via said pulley, and the mechanical lever multiplies the pull force and pulls the lever of the left and right Deadman's brake castor, thereby releasing the brake, and thereafter the wheel is free to rotate.

2. The fail safe brake system of claim 1, wherein said vehicle comprises a hitch with a hole type connector, and a pin couples said trolley to said vehicle.

3. The fail safe brake system of claim 1, wherein wheel configuration on the right and left deadman's brake castor wheel is aligned in the same axis and perpendicular to a direction of motion.

4. The fail safe brake system of claim 1, further comprising a brake wire routing conduit and brake wire tensioner.

5. The fail safe brake system of claim 1, wherein said hitch pin holder comprises
a hitch pin plate held by a mount plate onto said base plate; and
a pin that allows for the hitch pin plate to slide and rotate about the pin.

6. The fail safe brake system of claim 1, wherein the hitch pin plate moves forward when a pull force is applied to release the brake.

7. The fail safe brake system of claim 1, wherein the hitch pin plate moves to the original position when a pull force is released and engages the brakes.

8. The fail safe brake system of claim 1, wherein said brake wire tensioner further comprises a chassis, a small plate, brake wires from the left and right side brake castor wheels that connects to said hitch pin holder.

9. The fail safe brake system of claim 1, further comprising springs to create tension on said brake cables.

10. The fail safe brake system of claim 1, wherein each of said left Deadman's fixed castor and right Deadman's fixed castor include an integrated wheel with a drum brake inside and a spring-loaded lever that reduces the amount of pull force necessary to disengage a drum brake.

11. The fail safe brake system of claim 1, wherein the radius of the large radius pulley is twice the radius of the small radius pulley.

12. The fail safe brake system of claim 1, wherein tuning of the pull force is achieved by changing the ratio of length 1 and length 2 of the mechanical lever, and the magnitude of pull force required for brake release is pre-set by design of the mechanical lever, whereby a minimum pull force required to be exerted by the vehicle to which the trolley is coupled to releases the brakes and moves the trolley.
